(19) United States
(12) Patent Application Publication
(10) Pub. No.: US 2007/0138771 A1
(43) Pub. Date: Jun. 21, 2007

(54) Gas bag module

(75) Inventor: Dominik Schuetz, Waldaschaff (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/639,821

(22) Filed: Dec. 15, 2006

(30) Foreign Application Priority Data
Dec. 21, 2005 (DE) 20 2005 019 960.5

(51) Int. Cl. B60R 21/217

(52) U.S. Cl. 280/728.2

(57) ABSTRACT

A gas bag module has at least one first detent element adapted for engagement into a second detent element to form a detent connection to fasten the gas bag module to a vehicle-fixed component. An auxiliary locking element designed for engagement with a lock structure and a control element are provided. The control element prevents an engagement of the auxiliary locking element into the lock structure as long as the first detent element is not in engagement with the second detent element.

### FIELD OF THE INVENTION

The invention relates to a gas bag module.

### BACKGROUND OF THE INVENTION

Gas bag modules are know that have at least one first detent element which is constructed for engagement into a second detent element for fastening the gas bag module to a vehicle-fixed component.

Such fastenings are frequently used for fixing the gas bag module in the hub of a steering wheel, because in this way the actual installation process can be reduced to pushing the gas bag module into the steering wheel and, in particular, screw connections no longer have to be closed. However, it is time-consuming to check the correct locking state of such a detent connection, because the detent elements are arranged on the underside of the gas bag module and therefore can not be monitored visually.

### BRIEF SUMMARY OF THE INVENTION

It is an object of the invention to provide a simple and effective monitoring to ensure the correct locking of a detent connection for fastening a gas bag module.

This object is achieved in a gas bag module comprising at least one first detent element adapted for engagement into a second detent element to form a detent connection to fasten the gas bag module to a vehicle-fixed component. An auxiliary locking element designed for engagement with a lock structure and a control element are provided. The control element prevents an engagement of the auxiliary locking element into the lock structure to form an auxiliary connection as long as the first detent element is not in engagement with the second detent element.

As the auxiliary locking element can only engage into the lock structure when the load-bearing detent connection is correctly closed between the first detent element and second detent element, the conclusion can be drawn that the gas bag module is not correctly locked in the vehicle if the connection between the auxiliary locking element and the lock structure is not closed, which may for example be arranged at a visually apparent location or may prevent a mechanical movement of the gas bag module.

In a possible embodiment of the invention, the control element is formed by a section of the second detent element.

The second detent element is, for example, a spring wire.

The auxiliary locking element may be formed for example by an elastically deflectable tongue on a module housing or on a generator carrier of the gas bag module.

The lock structure is preferably constructed on the vehicle-fixed component, which on the one hand allows the gas bag module to be locked with little play, and on the other hand reduces the manufacturing costs, because no further components have to be provided.

The lock structure has, e.g., a shoulder against which the auxiliary locking element comes into abutment to form the auxiliary connection.

The auxiliary connection between the auxiliary locking element and the lock structure does not have to bear any great loads, so that this auxiliary connection does not need to meet any special requirements as regards its stability. As the gas bag module is held in the vehicle with as small an amount of play as possible, a simple structure such as, for instance, a shoulder, is sufficient.

The auxiliary locking element is preferably pre-stressed in a locking direction before engagement into the lock structure. Therefore, as soon as the auxiliary locking element is released by the control element, it can automatically move into a locking position in which the engagement with the lock structure is possible.

The gas bag module can be constructed such that in a correctly locked state of the detent connection between the first and the second detent element, it is movable against a restoring force in an insertion direction and in a not correctly locked state of the detent connection between the first and the second detent element, in which the auxiliary locking element is not in engagement with the lock structure, is acted upon by the restoring force such that it assumes a different position in the insertion direction than in the correctly locked state.

The auxiliary connection between the auxiliary locking element and the lock structure also provides, for example, for an exact positioning of the gas bag module in the z direction. This design presents itself especially in so-called floating horn modules, in which the entire gas bag module is pressed against a restoring spring into the steering wheel to actuate a horn. The restoring spring moves the gas bag module back into its initial position again as soon as the driver releases it.

This restoring force may be utilized in accordance with the invention in order to push the gas bag module beyond its correctly locked position outwards from the steering wheel, if the detent connection between the first and the second detent element fixing the gas bag module in the vehicle and the auxiliary connection between the auxiliary locking element and the lock structure are not correctly closed. Preferably, however, the auxiliary connection between the auxiliary locking element and the lock structure can only be established if the detent connection between the first and the second detent element, which connects the gas bag module in a load-bearing manner with the vehicle-fixed component, is also correctly closed.

If the gas bag module is in the not correctly locked state, it is possible to utilize the restoring force and to allow the restoring spring to push the gas bag module a further distance out from the steering wheel, so that it can be detected immediately that the gas bag module is not in a correctly locked state.

Preferably, the first detent element and the auxiliary locking element are arranged spatially apart from each other. For example, the first detent element, as is known, can be fastened underneath the base of the module housing, whilst the auxiliary locking element can be arranged at the side, e.g. on a guide for the gas bag module in the steering wheel.

For unlocking, the auxiliary locking element can preferably be transferred into its non-locked state by the control element. The locking movement here is, for example, reversible.

Preferably, it is not possible to release the detent connection between the first and second detent elements and to remove the gas bag module from the vehicle-fixed component, without unlocking the auxiliary connection between the auxiliary locking element and the lock structure.

In the case of unlocking by a movement of the control element, preferably the auxiliary locking element is released from the lock structure and the first detent element is released from the second detent element simultaneously, so that a dismounting can be brought about quickly and simply.

### BRIEF DESCRIPTION OF THE DRAWINGS

FIG. 1 shows a diagrammatic sectional view of a gas bag module according to the invention in a correctly locked state; and

FIGS. 2a to 2c show the locking and unlocking processes in the fastening/removal of the gas bag module according to the invention.

### DETAILED DESCRIPTION OF A PREFERRED EMBODIMENT

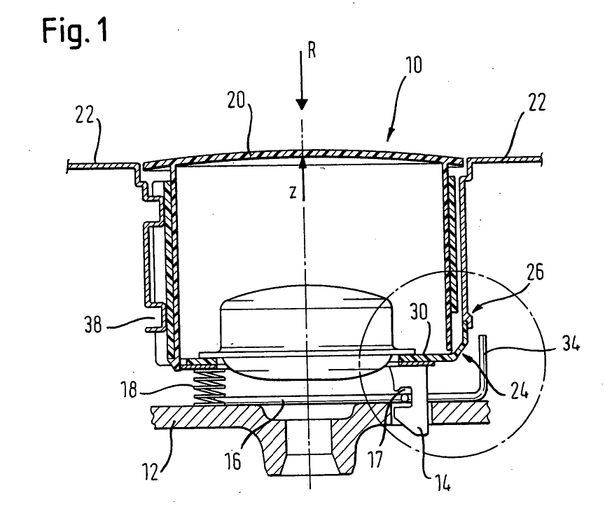

In FIG. 1 a gas bag module 10 is shown, which is fastened by means of a detent connection to a component 12 which is fixed to the vehicle, here the hub of a steering wheel. The gas bag module 10 has a housing with a covering cap 20, side walls adjoining the covering cap 20, and a base which is formed here by a generator carrier 30. A gas generator and a gas bag, which is not shown, are held in a known manner in the gas bag module 10.

The detent connection consists of one or more first detent elements 14 (here, only one detent hook is shown, which is arranged on the underside of the gas bag module 10), which engage(s) into a second detent element 16, which here is a detent spring bent from a spring wire. A different, more or less rigid, possibly elastically stressed detent means could, of course, also be provided instead of a spring wire. Of course, vice versa, for example the first detent element 14 could also be constructed as a spring wire and the second detent element 16 as a detent hook or pin or suchlike.

In the correctly locked state as shown, the first detent element 14 is in engagement with the second detent element 16, the gas bag module 10 being secured in a load-bearing manner against removal from the vehicle-fixed component 12, in the z direction. However, a certain play exists in the z direction. In fact in the example shown, a section of the second detent element 16 lies in a recess 17 of the first detent element 14.

The play in the z direction is intentional, in order to be able to press the gas bag module 10 into the steering wheel in accordance with the floating horn principle, to close horn contacts (not illustrated). For this, the gas bag module 10 is moved against the restoring force of a restoring spring 18.

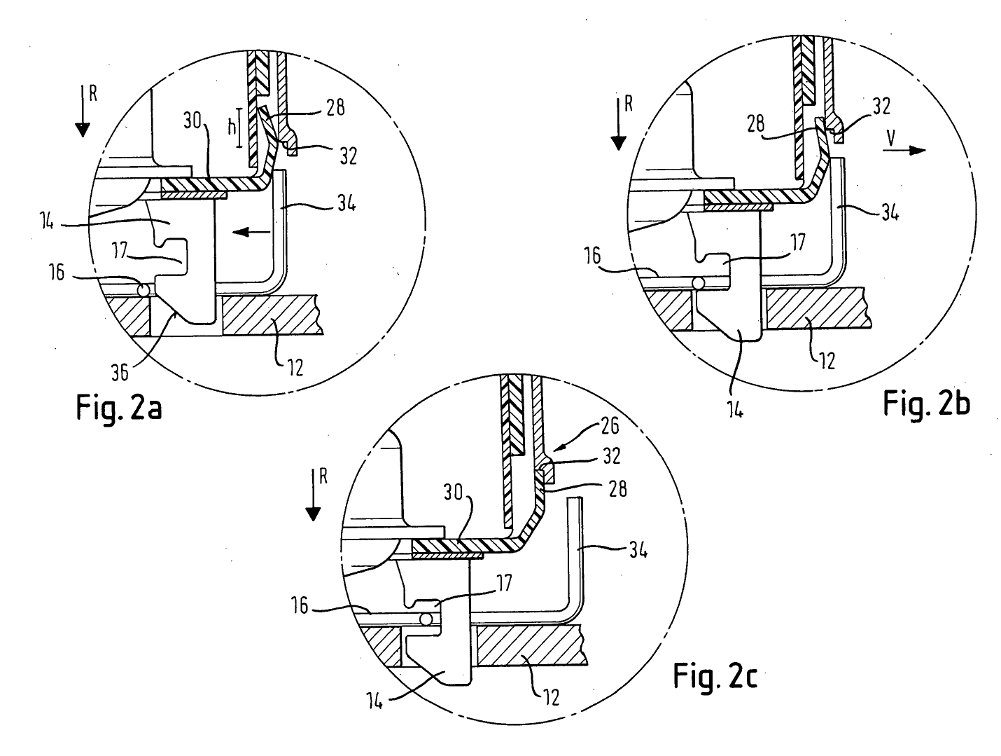

Monitoring of the detent connection 14, 16 is difficult. The gas bag module 10 must be prevented from remaining in a position in which the detent elements 14, 16 are in fact already in contact with each other, but the second detent element 16 remains deflected and has not yet correctly engaged into the recess 17 in the first detent element 14 (FIG. 2a). This will also be referred to as “not correctly locked state” below. However, the detent elements 14, 16 are generally neither visible nor accessible for touch from the interior of the vehicle.

In the gas bag module 10 shown here, provision is made that the restoring spring 18 causes such a great z stroke that with a not correctly closed detent connection 14, 16, the gas bag module 10 would project by a distance h out from the component 12 which is fixed to the vehicle, i.e. the steering wheel, for example.

On the other hand, in the correctly locked state, the covering cap 20 of the gas bag module 10 terminates flush with an outer side of a vehicle facing, in particular steering wheel facing 22.

However, this configuration can only be achieved when an auxiliary locking element 24 is in engagement with a lock structure 26. As long as this auxiliary connection is not closed, the gas bag module 10 is in a not correctly locked state. The realization of the auxiliary connection 24, 26 is shown in further detail in FIGS. 2a to 2c. The auxiliary locking element 24 in this case is an elastically deflectable tongue 28 on the generator carrier 30, whilst the lock structure 26 is formed by a shoulder 32 on a section of the vehicle lining 22 running approximately parallel to a side wall of the gas bag module 10 (e.g. a steering wheel back covering).

A control element 34, which is realized here as an upwardly bent section of the spring wire forming the second detent element 16, ensures that the auxiliary locking element 24 can only come into engagement with the lock structure 26 when the second detent element 16 has correctly engaged into the first detent element 14. Of course, the control element 34 does not have to be formed integrally with the second detent element 16; it may also be a separate component which is uncoupled or coupled therewith. The control element 34 is moved together with or by the second detent element 16.

In closing the detent connection between the first and the second detent element 14, 16, the second detent element 16 is firstly pressed to the side by a guide rampl 36 at the lower end of the first detent element 14, towards the left in the figures. During the sideways movement, the control element 34 also moves towards the left (arrow in FIG. 2a). The dimensions of the control element 34 and auxiliary locking element 24 are such that in the not correctly locked state which is now present, in which the second detent element 16 is in fact in contact with the first detent element 14 but has not yet engaged into the recess 17 of the first detent element 14, the control element 34 is in abutment against the auxiliary locking element 24 such that the latter is held spaced apart from the lock structure 26. The auxiliary connection between the auxiliary locking element 24 and the lock structure 26 therefore can not be closed. Consequently, however, the movement in the z-direction of the gas bag module 10 is not restricted strongly enough, so that the restoring spring 18 can press the gas bag module 10 beyond the surface of the vehicle lining 22. It can therefore be detected immediately that the detent connection between the first and the second detent element 14, 16 is not in the correctly locked state.

However, when the gas bag module 10 now moves in the insertion direction R further against the restoring force of the restoring spring 18, then the detent hook passes the detent spring, as shown in FIGS. 2b and 2c, so that the second detent element 16 comes into engagement with the recess 17 in the first detent element 14. The auxiliary locking element 24, i.e. the elastically deflectable tongue 28in this case, is pre-stressed into a locking direction V (directed towards the right here). The control element 34 likewise moves towards the right, corresponding to the movement of the second detent element 16, so that gradually the auxiliary locking element 24 moves in the locking direction V (FIG. 2b). An over-pressing in the insertion direction R finally makes provision that the auxiliary locking element 24 reaches the correct position in order to engage into the lock structure 26. In this case, the tongue 28 therefore comes to rest against the shoulder 32 in the lateral section of the vehicle lining 22. “Over-pressing” is to be understood to mean that the gas bag module 10 is moved further in the insertion direction R than would be necessary for the engagement of the second detent element 16 into the first detent element 14. The correctly locked position of the gas bag module 10 is shown in FIG. 2c.

A closing of the auxiliary connection 24, 26 is only possible when the first detent element 14 is in correct engagement with the second detent element 16.

Several auxiliary connections 24, 26 may be provided distributed over the periphery of the gas bag module 10, which alternate for example with the guides 38 shown on the left side of FIG. 1.

The auxiliary connection 24, 26 not only makes possible a monitoring for a correct locking of the detent connection 14, 16, but may be additionally or separately used to precisely adjust the z height of the gas bag module 10 in a simple manner. In particular, the adjustment is independent of the exact z position of the detent connection 14, 16. The auxiliary connection 24, 26, in particular together with the guide 38, also allows a very precise positioning of the gas bag module 10 with respect to the vehicle lining 22 in all spatial directions.

In all cases, the auxiliary connection 24, 26 only has to take up the small forces occurring in daily vehicle operation. The illustrated form of the auxiliary connection 24, 26 for example is entirely sufficient for this purpose. As shown in FIG. 2c, no contact has to exist between the second detent element 16 and the first detent element 14 in normal driving operation. In the case which is shown, the section of the second detent element 16 forming the actual lock is situated within the recess 17 in the first detent element 14, without contact all around. In this way, any undesired rattling can be prevented. If, in an accident, an activation of the gas bag module 10 occurs, the gas bag module 10 is drawn upwards in the z direction during the unfolding of the gas bag so far that the load is practically entirely taken up by the detent connection 14, 16.

The auxiliary locking element 24 and the lock structure 26 could also be placed closer to the upper end of the gas bag module 10 and optionally form a visual display which indicates a not correctly locked detent connection 14, 16.

If the gas bag module 10 is to be separated from the vehicle-fixed component 12, then for unlocking of the detent connection, the second detent element 16 is moved towards the left (in the figures) against the locking direction V. Basically, the sequence shown in FIGS. 2a to 2c is run through in reverse order. The control element 34 comes into abutment against the auxiliary locking element 24 and presses the latter out of engagement with the lock structure 26. At the same time, the second detent element 16 moves out of engagement with the first detent element 14. The restoring spring 18 presses the gas bag module 10 so far upwards that it projects above the surface of the vehicle lining 22 and can be removed.

The gas bag module which has been presented could also be arranged on a passenger side, in a back rest of a vehicle seat or at another suitable location in a vehicle.

1. A gas bag module comprising:
at least one first detent element (14) adapted for engagement into a second detent element (16) to form a detent connection to fasten the gas bag module (10) to a vehicle-fixed component (12),
an auxiliary locking element (24) which is designed for engagement with a lock structure (26),
and a control element (34), the control element (34) preventing an engagement of the auxiliary locking element (24) into the lock structure (26) as long as the first detent element (14) is not in engagement with the-second detent element (16).

2. The gas bag module according to claim 1, wherein the control element (34) is formed by a section of the second detent element (16).

3. The gas bag module according claim 1, wherein the second detent element (16) is a spring wire.

4. The gas bag module according to claim 1, wherein the auxiliary locking element (24) is formed by an elastically deflectable tongue (28) on one of a module housing and a generator carrier (30) of the gas bag module (10).

5. The gas bag module according to claim 1, wherein the lock structure (26) is designed on one of the component (12) which is fixed to the vehicle and a vehicle lining (22).

6. The gas bag module according to claim 1, wherein in that the lock structure (26) has a shoulder (32) against which the auxiliary locking element (24) comes into abutment.

7. The gas bag module according to claim 1, wherein the auxiliary locking element (24) is pre-stressed into a locking direction (V) before engagement into the lock structure (26).

8. The gas bag module according to claim 1, wherein in a correctly locked state, the gas bag module (10) is movable against a restoring force in an insertion direction (R), and the gas bag module (10), in a not correctly locked state, in which the auxiliary locking element (24) is not in engagement with the lock structure (26), is acted upon by the restoring force such that it assumes a different position in the insertion direction (R) than in the correctly locked state.

9. The gas bag module according to claim 1, wherein the first detent element (14) and the auxiliary locking element (24) are arranged spatially apart from each other.

10. The gas bag module according to claim 1, wherein for unlocking, the auxiliary locking element (24) is transferred into its non-locked state by the control element (34).

11. The gas bag module according to claim 1, wherein during an unlocking of the detent connection, by a movement of the control element (34), and at the same time, the auxiliary locking element (24) is released from the lock structure (26) and the first detent element (14) is released from the second detent element (16).
